(19) United States
(12) Patent Application Publication
(10) Pub. No.: US 2021/0349980 A1
(43) Pub. Date: Nov. 11, 2021

(54) Method and Apparatus for Processing Requests for Access by Biometric Verification

(71) Applicant: Yariv Glazer, Palo Alto, CA (US)

(72) Inventor: Yariv Glazer, Palo Alto, CA (US)

(21) Appl. No.: 17/246,665

(22) Filed: May 2, 2021

Related U.S. Application Data
(60) Provisional application No. 63/020,553, filed on May 6, 2020.

(51) Int. Cl. G06F 21/32; G06F 21/62

(52) U.S. Cl. CPC G06F 21/32; G06F 21/6218

(57) ABSTRACT

A method and apparatus for processing requests for access to particular activities by utilizing biometric/threshold data examinations to verify the identity of the requestor making the request, wherein a data processor system is programmed to permit a more-restricted or a less-restricted access to the particular activity to be granted by specifying in the stored template the enrollee biometrics/threshold data required for the more-restricted access and that required for the less-restricted access; and during the operational phase, to sense and compare the corresponding biometric/threshold data of the requestor with that in the stored template in determining whether to grant or deny the requested access.

This application is a continuation application of U.S. Provisional Application No. 63/020,550, filed May 6, 2020, and incorporates by reference the disclosure therein.

### RELATED APPLICATION

Methods for processing requests for access by biometric verification are generally known. See for example, U.S. Pat. No. 7,865,937 incorporated by reference herein. Biometric verifications methods may utilize a unimodal verification system or a multi-modal verification system. A multi-modal verification system is disclosed in U.S. Pat. No. 8,700,557 incorporated by reference herein. Biometric verifications methods may also utilize a self-adaptive multimodal biometric authentication method and system. See for example, Patent Application No. 2009/0037978 incorporated by reference herein.

### FIELD AND BACKGROUND OF THE INVENTION

The present invention relates to a method and apparatus for processing requests for access to particular activities by biometric verification. The invention is particularly useful with respect to granting access to bank accounts, motor vehicles, apartments, personal information, online payments, and various phone services. The invention is therefore described below particularly with respect to such applications, but it will be appreciated that the invention could be used in many other applications involving biometric access control.

Many techniques are known for processing requests for access to particular activities by utilizing biometric/threshold data examinations to verify the identity of the individual making the request. Such known techniques generally include an enrollment phase, in which a template of biometric/threshold data identifying the enrollee stored in a data processor; and an operational phase, in which each requestor requesting access causes the data processor to receive a biometric sample of the respective requestor, to compare the features of the received biometric sample with those stored in the template, and to determine from such comparison whether or not to grant or deny the requested access. The biometric/threshold data template identifying the enrollee, as stored in the data processor system, may include voice characteristics, facial characteristics, fingerprints, handwriting, bone structure, and the like.

The use of conventional mechanical keys or passwords for controlling access involves a yes/no system for granting or denying the requested access. As distinguished from such conventional systems, biometric/threshold system, using a template of biometric/threshold data identifying the enrollee for controlling the requested access, involves a scoring system in which the request for access receives a passing or failing score, based on how close the sensed biometric/threshold features of the requestor requesting access in the operational phase match the enrollee biometric/threshold features stored in the template during the enrollment phase. Thus, an “access granted” determination is made only when the “matching score” is found to be at or above a specified one.

In this respect, it is to be noted that the “matching score” is inversely related to the disparity between the stored biometric characteristics and the corresponding sensed biometric characteristics from the enrollee. Thus, in a range of 0-10, a “score” of “10” (corresponding to a disparity of “0”) verifies that the requestor is indeed the enrollee.

One drawback in the known biometric/threshold verification systems is that such systems, being based on relative scores, have a high false acceptance rates (FARs), wherein a request is incorrectly accepted, and also high false rejection rates (FRRs), wherein a request is incorrectly rejected. Thus, if the “passing” matching score is set higher in order to reduce FARs, this will also have the effect of increasing FRRs; and if it is set lower to reduce FRRs, it will have the effect of increasing the FARs. One known technique for reducing both the FARs and FRRs is by providing the system with dynamic, self-adaptive means, wherein the templates stored in the enrollment phase are automatically updated according to the results produced during the processing of access requests in the operational phase.

Another drawback in the known biometric/threshold verification systems for processing access requests is that each system deals with only one activity and either grants or denies access to the particular activity. For example, if access to a bank account is requested, the access is either granted or denied. However, one activity requested to be accessed may be merely to view a balance, and another activity may be to withdraw a sum. The enrollee may very well wish to be liberal in permitting viewing the bank balance, but may require a more severe biometric examination to be applied for withdrawing sums from a bank account.

Another example would be for the keyless entry of an apartment, wherein a much more severe biometric examination may be appropriate where the apartment contains articles of particular value, as compared to where it does not.

In the forgoing examples, applying the same biometric examination to all types of requests will result in a high rate of FRRs and/or FARs. Thus, if a particular template is liberalized so as to be acceptable for a less-restrictive type of access, (e.g., viewing a bank balance), this will tend to increase the FARs with respect to more-restrictive type of access (e.g., withdrawing sums); and when the template is made more severe so as to prevent the possibility of a wrongful withdrawal of sums, this will increase the FRRs with respect to requests for merely viewing the balance.

Another drawback in the prior art are situations where it may be desired to condition a granted access to certain prescribed conditions of behavior, and to automatically terminate the granted access if the requestor does not comply with certain specified conditions, such as showing alertness when granted access to operate a motor vehicle or when operating the vehicle during certain times (e.g., at night or during week days) is not specifically authorized.

### OBJECT AND BRIEF SUMMARY OF THE PRESENT INVENTION

An object of the present invention is to provide a method, and also an apparatus, for processing access requests in a manner having advantages in one or more of the above respects.

According to a broad aspect of the present invention, there is provided a method of processing requests by individuals for access to particular activities by utilizing biometric/threshold data examinations to verify the identity of the individual making the request, said method comprising: an enrollment phase, in which a template of biometric/threshold data identifying an enrollee stored in a data processor system; and an operational phase, in which each requestor requesting access to a particular activity causes the data processor system to receive a biometric sample of the respective requestor, to compare the received biometric sample with those stored in the template, and to determine from such comparison whether or not to grant or deny the requested access; characterized in that the data processor is programmed to permit a more-restricted or a less-restricted access to the particular activity to be granted by specifying in the stored template the enrollee biometrics/threshold data required the more-restricted access and that required for the less-restricted access; and during the operational phase, to sense and compare the corresponding biometric/threshold data of the requestor with that in the stored template in determining whether to grant or deny the requested access.

According to further features in the embodiments of the invention described below, the data processor system is programmed such that, during the operational phase, it: (a) grants an unrestricted access when said comparisons results in a matching score which is equal to or exceeds a “high score” stored in the data processor; (b) denies any access when said comparison results in a matching score which is below a “low score” stored in the data processor; and (c) causes another biometric sample of the requestor to be received, and to be used together with the first-mentioned biometric sample, to determine whether or not to grant a restricted access.

In some described embodiments, the data processor system is programmed to process a request for one of a plurality of different levels of restricted access, each level having a different “low score” to be met or the respective level of restricted access to be granted.

Many embodiments of the invention are described below include examples wherein the data processor system is programmed to permit a plurality of different thresholds to be specified for a biometric characteristic in determining whether to grant or deny the requested access (sometimes called the “multiple-threshold” approach). In other examples, the data processor system is programmed to permit a plurality of different biometric characteristics to be prescribed in determining whether to grant or deny the requested access (sometimes called the “multimodal” approach).

It will be appreciated that still other embodiments could use both approaches, could use more than two thresholds for a respective biometric characteristic, and/or could use more than two biometric characteristics. Where a plurality of biometric characteristics is used, the desired sequence of sensing the respective biometric characteristics, including concurrent sensing, can also be specified.

According to further features in the preferred embodiments of the invention described below, the biometric/threshold data is stored in a database of the data processor system; the access requests during the operational phase are received in an application server in the data processor system communicating with the database; the access requests are processed in an access governor unit in the data processor system; and the determinations of whether or not the access requests are granted or denied are determined by a self-adaptive unit in the data processor system communicating with the access governor unit and the application server.

According to still further features in some described preferred embodiments, the programmed data processor system is programmed: to extract a predetermine number of biometric features from a biometric sample; to compare the extracted features with a General Most Significant Features Vector (GMSFV), representing the features having the highest standard deviation of the general enrollee population, to produce an Average Score Vector (ASV), representing for each feature, the difference between each GMSFV feature and the corresponding extracted feature; and to determine from the vector ASV, a Personal Features Vector (PFV), representing the features which have the most difference from the corresponding features of the vector GMSFV, to be used during the operational phase in comparing the features of the received biometric sample with those stored in the template, and in determining from such comparison whether or not to grant or deny the requested access.

Several embodiments of the invention are described below wherein the data processor system is programmed to permit updating requests for access to bank accounts, including: a restricted access for only viewing a bank balance, for which case a predetermined biometric/threshold data template is stored; and a non-restricted access for also withdrawing sums from the bank account, for which case a more severe biometric/threshold data template is stored.

Other embodiments are described wherein the data processor system is programmed to permit access to a motor vehicle, including: a restricted access, restricted to a specified time, place, speed or other driving conditions, for which case a predetermined biometric/threshold data template is stored; and a non-restricted access, for which case a more severe biometric/threshold data template is stored.

Still other embodiments are described wherein the data processor system is programmed to permit entry into an apartment, including a restricted: entry into an apartment restricted to when it does not contain valuables, for which case a predetermined biometric/threshold data template is stored; and a non-restricted entry into an apartment even when containing valuables, for which case a more severe biometric/threshold data template is stored.

Still further embodiments are described wherein the data processor system is programmed to permit access to personal information including: restricted access, restricted to a prescribed limited amount of information, for which case a predetermined biometric/threshold data template is stored; and a non-restricted access to an unlimited amount of information for which case a more severe biometric/threshold data template is stored.

Yet other embodiments are described wherein the data processor system is programmed to permit access to make online payments including: a restricted access, restricted to prescribed limited to specified small payments, for which case a predetermined biometric/threshold data template is stored; and a non-restricted access to unlimited payments, for which case a more severe biometric/threshold data template is stored.

Still further embodiments are described wherein the data processor system is programmed to permit access to a phone to be for: a restricted use, for which case a predetermined biometric/threshold data template is stored; and a non-restricted use, for which case a more severe biometric/threshold data template is stored.

The biometric/threshold data may include facial characteristics, voice characteristics, fingerprint characteristics, and many other biometric characteristics, presently used for verifying identity.

According to still further aspects of the present invention, there is provided apparatus for processing requests for access to particular activities in accordance with the foregoing method.

As will be described more particularly below, such a method and apparatus enable processing access requests for many types of activities, including variations thereof, in a manner which is quick, efficient, dynamically self-adaptive, and substantially reduces false rejection rates (FRR) and false acceptance rates (FAR).

Further features and advantages of the invention will be apparent from the description below.

### BRIEF DESCRIPTION OF THE DRAWINGS

The invention is herein described, for purposes of example only, with reference to the accompanying drawings, wherein:

FIG. 1 is block diagram of an access-request processing system constructed in accordance with the invention;

FIG. 2 is a block diagram illustrating various options that may be selected in implementing the system of FIG. 1;

FIG. 3 is a flow diagram illustrating the overall operation of the system of FIG. 1;

FIG. 4 is a block diagram illustrating a preferred implementation of the system of FIG. 1;

FIG. 5 and FIG. 6 are flow diagrams illustrating examples of operations of the system of FIG. 4 with respect to accessing bank accounts;

FIG. 7-FIG. 10 are flow diagrams illustrating examples of the system of FIG. 4 with respect to the operation of motor vehicles;

FIG. 11 and FIG. 12 are flow diagrams illustrating examples of operation of the system of FIG. 4 with respect to access to an apartment, depending on whether or not the apartment contains valuables;

FIG. 13 is a flow diagram illustrating an example of the operation of the system of FIG. 4 with respect to access to personal data, such as medical data;

FIG. 14 is a flow diagram illustrating the operation of the system of FIG. 4 with respect to access to make online payments;

FIG. 15 is a flow diagram illustrating an example of the operation of the system of FIG. 4 with respect to access to various uses of a telephone;

FIG. 16-FIG. 18 are flow diagrams illustrating operations of a system of FIG. 4 to reduce effects of sensor environmental factors;

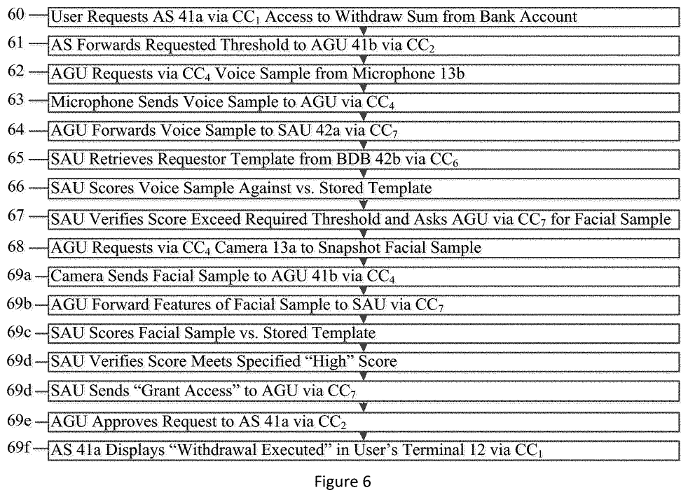

and FIG. 19 is a flow diagram illustrating an example of the operation of the system of FIG. 4 to create and then update a biometric/threshold data template stored during the enrollment both creating and the updating being according to the biometric features found to be most relevant for identifying the enrollee.

It is to be understood that the drawings, and the description below, are provided primarily for purposes of facilitating understanding the conceptual aspects of the invention and various embodiments thereof, including what is considered to be a preferred embodiment. In the interests of clarity and brevity, no attempt is made to provide more details than necessary to enable one skilled in the art, using routine skill and design, to understand and practice the described invention. It is to be further understood that the embodiments described are for purposes of example only, and that the invention is capable of been embodied in other forms and applications then described herein.

### DESCRIPTION OF THE INVENTION AND PREFERRED EMBODIMENTS

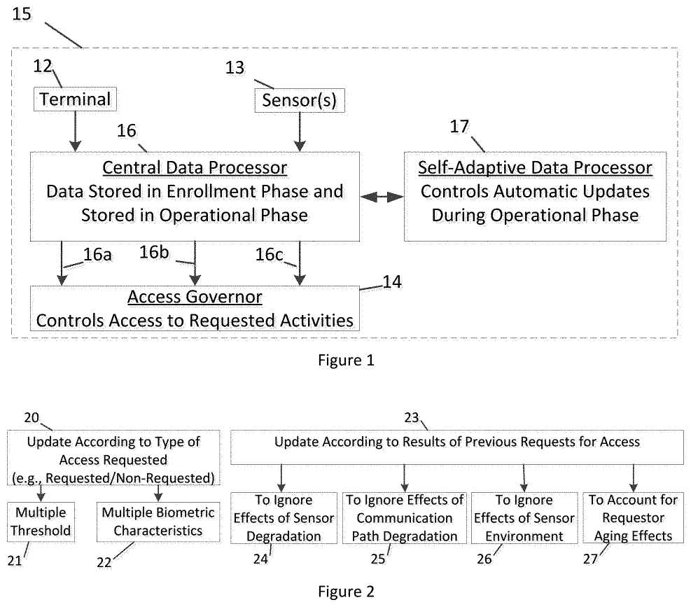

Overall System of FIG. 1 to FIG. 4

FIG. 1 illustrates an overall system constructed in accordance with the present invention for processing a request for access to various activities by utilizing biometric/threshold data examinations to verify the identity of the individual making the request.

Briefly, as illustrated in FIG. 1, the system includes a terminal 12 for use in inputting the biometric information into the system, one or more sensors 13 for sensing the respective biometric characteristics, an access governor 14 controlling the access to the activity requested, and a data processor system, generally designated 15, for use in processing the input data during both the enrollment phase and the operational phase. The data processor system 15 includes a central data processor 16 communicating with the terminal 12, the sensor(s) 13, and the access governor 14.

According to the present invention, the data processor system 15 also includes a self-adaptive data processor 17 which communicates directly with the central data processor 16 in order to enable it to perform its various self-adaptive functions. The main self-adaptive function is performed during the operational phase of the central data processor 16, wherein it compares the biometric data stored during the enrollment phase and biometric data received during the operational phase, and produces one of the following three output signals to the access governor 14; a “Grant Access” signal on output line 16a; a “Deny Access” signal on output line 16b; and a “Terminate Access” signal on output line 16c.

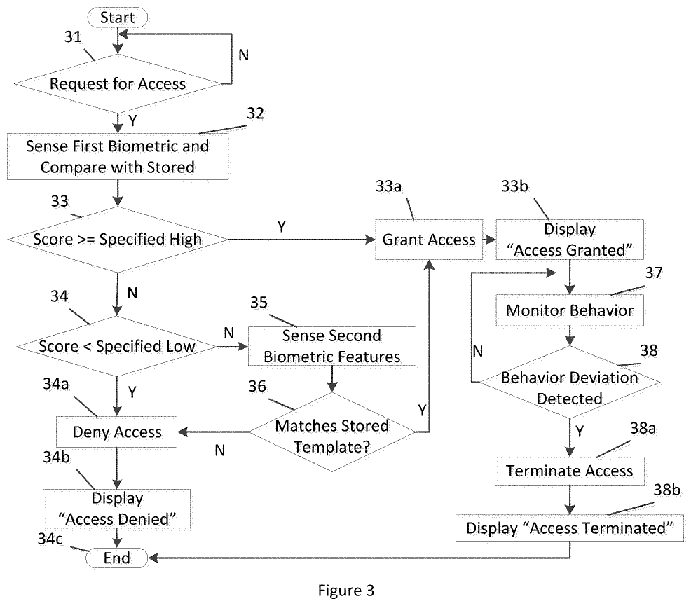

The central data processor 16 may perform one or more updating, or resetting, functions according to a number of options as illustrated in FIG. 2. Thus, as indicated by box 20, or resetting, the updating could be according to the type of access requested, e.g., restricted or non-restricted access, such an option can by effected by a multiple-threshold approach, as indicated by box 21, wherein the data processor is programmed to permit a plurality of different thresholds to be prescribed for a biometric characteristic in determining whether to grant or deny the requested access. Alternatively, the updating or resetting could be effected by a multiple-biometric-characteristic approach, as indicated by box 22, wherein the data processor is programmed to permit a plurality of different biometric characteristics to be prescribed in determining whether to grant or deny the requested access.

Another updating or resetting option illustrated by block 23 in FIG. 2, is according to the results of processing previous requests for access. This may be done for purposes of reducing the effects of various environmental influences during the operational phase, including: reducing the effects of sensor degradation, as indicated by block 24; reducing the effects of communication path degradation, as indicated by block 25; reducing the effects of other sensor environments, such as noisy environment, as indicated by block 26; and accounting for gradual changes in the requestor's biometric characteristics, such as aging, as indicated by block 27.

The enrollment phase is basically always the same. In this phase, the enrollee identifies himself (or herself) via the terminal 12 by actuating the sensor or sensors 13 located in the vicinity of the terminal to sense the appropriate biometric characteristic(s) of the enrollee and to store same in the data processor system 15. At the same time, the enrollee identifies the sensor(s) available, e.g., camera, microphone, fingerprint reader, etc.

The level of certainty, (i.e., matching score) required for a subsequent requestor to be granted the requested access is programmed in the central data processor 16. Thus, if the access is to be non-restricted, (e.g. to include withdrawing funds from a bank account), the required “matching-score” would be relatively high (“10” is perfect), whereas if the access requested is restricted, (e.g., merely to view a balance in a bank account), the required “matching score” would be lower.

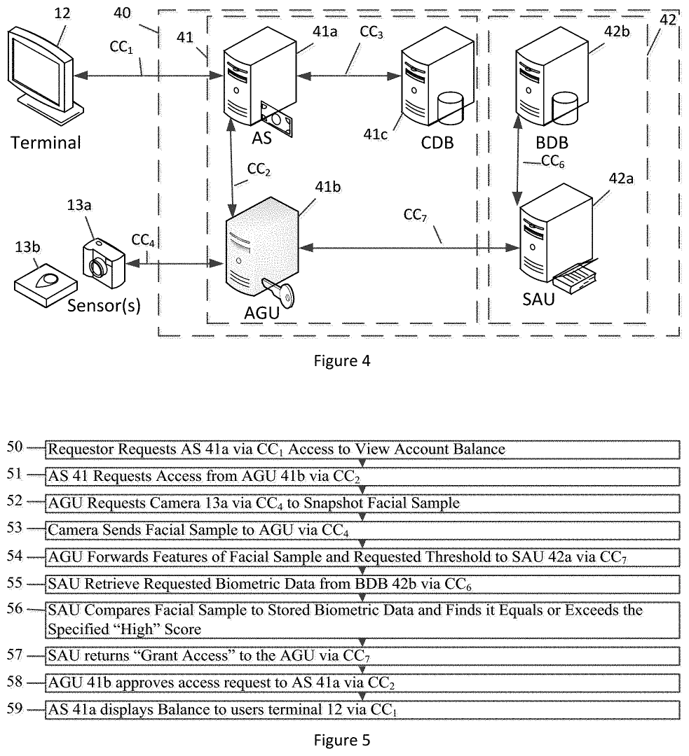

The flowchart illustrated in FIG. 3 illustrates the system during the operational phase, when a requestor requests access to a particular activity, (e.g., re a bank account). These operations performed during the operational phase, are designed to subject the requestor to an examination of requestor's biometric characteristics in a self-adaptive manner according to the identity-verification level required for the respective access requested, i.e., a high “matching score” for a non-restricted access such as to include withdrawing a sum form a bank account, or a lower “matching score” required for a restricted request such as for merely viewing a bank balance.

Thus, as shown in FIG. 3, the operational phase begins with a request for access by the requestor (block 31), whereupon the appropriate sensor is actuated to sense a specified biometric characteristic of the requestor and to compare it with the biometric characteristic of the requestor stored during the enrollment phase (block 32).

If the high “matching score” prescribed for non-restricted access is met (block 33), access is granted to the access governor 14 (block 33a), and this fact is also displayed in the terminal 12 (block 33b).

If not, the system now decides whether the score resulting from the first biometric feature examination (block 32) is below the “High” (non-restricted access) and “Low” (restricted access) scores specified for the respective access type requested (block 34). If the score is below the “Low” level, the access is denied, a message is displayed in terminal 12, and the operation ends (blocks 34a-34c).

The data processor system is programmed to proceed from block 34 according to the either multiple-threshold option (block 21 of FIG. 2) or the multiple biometric-characteristic option (block 22 of FIG. 2). In the first option, it senses a second biometric sample (block 35) which in this case is the same biometric characteristic but applies a lower threshold to be met for the respective restricted-access requested. If the multiple-biometric characteristic option is selected, another biometric characteristic is sensed, and a lower “matching score” is used with respect to the combination of the two sensed biometric characteristics.

Under either option, if the “matching score” prescribed for a restricted-access request is still not found to exist, the terminal 12 is controlled to display “Access Denied” and the operation ends (blocks 34a-34c). However, if the prescribed “matching score” is now found to exist, the terminal 12 is controlled to grant the requested restricted access (block 33a), and to displayed this fact (blocks 33a, 33b).

The data processing system is programmed to enable a further control to be effected, namely to monitor the requestor behavior after access has been granted, whether restricted or non-restricted, to see whether the behavior meets prescribed conditions. For example, if the access is for operating a motor vehicle, the behavior of the requestor (driver) may be monitored to ensure that certain prescribed conditions, as to speed, alertness, time of day, etc., be met, and if not, any previously granted access may be terminated. In the latter case, the driver is alerted to this fact, and/or the misbehavior of the driver may be recorded for subsequent review and action if necessary. The flowchart of FIG. 3 illustrates the behavior monitoring option (block 37) which terminates access if a specified misbehavior is detected (blocks 38, 38a, 38b).

FIG. 4 illustrates, for purposes of example, the main components of the data processing system, therein generally designated 40. It also illustrates the communication paths between components of the system and the terminal 12 and the sensors means 13.

Thus, the data processing system 40 (corresponding to data processor system 15 in FIG. 1) includes a central data processor 41 (corresponding to 16 in FIG. 1), which performs the normal data processing functions at the respective location; and a self-adaptive data processor 42 (corresponding to 17 in FIG. 1), which controls the automatic updating, of the central data processor with respect to the biometric data of the respective enrollee. As shown in FIG. 4, the central data processor 40 includes an application server 41a which communicates with the terminal 12 via communication channel CC1, and an access governor unit (AGU) 41b, which communicates with the application server 41a via communication channel CC2. Central data processor 41 further includes a common database CDB 41c, which communicates with the AS 41a via communication channel CC3. The AGU 41b also communicates with the sensors means 13 (FIG. 1) via communication channel CC4.

The Self-adaptive data processor 42 includes a self-adaptive unit SAU 42a and a biometric database BDB 42b communicating therewith via communication channel CC6. The SAU 42a also communicates with the AGU 41b via communication channel CC7.

The foregoing communication channels CC1-CC7 may be wired channels and/or wireless channels. In addition, the terminal 12 may be a computer keyboard, a smart phone, an RFID (radio frequency identification device), or the like, for identifying the enrollee during the enrollment phase, or the access requestor during the operational phase. The sensor means 13 may be but a single sensor, such as a microphone for sensing voice characteristics. In most cases, however, there will be a plurality of sensors, such as a microphone, a camera, a fingerprint sensor, or any other sensors known for sensing particular biometric characteristics used for identity verification.

The access governor unit 41b controls the access to a particular activity requested, depending upon the application of the system. For purposes of example, a number of such applications are described below and are shown in the accompanying flow diagrams.

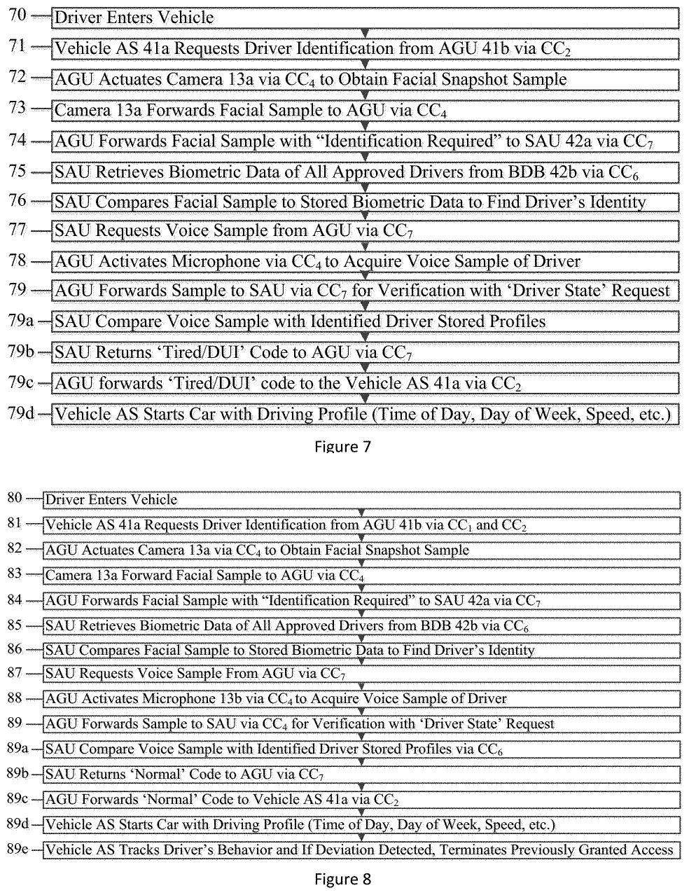

### The Embodiments of FIG. 5 and FIG. 6

The flow diagrams of FIG. 5 and FIG. 6 illustrates two embodiments of the invention applicable to bank accounts, to require a lower degree of certainty of identity merely to view a bank balance than that required to withdraw a specified sum or different specified sums. In these examples, the sensor means 13 is or include a camera 13a for sampling facial features and a microphone 13b for sampling voice features of the enrollee during the enrollment phase, and also of each requestor for access during the operational phase.

In the enrollment phase, the enrollee merely inputs his (or her) identification via terminal 12, and also sets forth the type of sensor means available at the terminal. These operations are substantially the same for all the embodiments of the invention described below.

As shown in the flow diagram of FIG. 5, the operational phase begins with a request inputted via terminal 12 for access to a particular activity to the application server AS 41a via communication channel CC1, e.g., to view an account balance (block 50). This request is forwarded via communication channel CC2 to the access governor unit AGU 41b (block 51). The access governor unit AGU actuate sensor means 13, in this case camera 13a, via communication channel CC4 (block 52). A facial sample is then made and forwarded to the access governor unit AGU via the same communication channel CC4 (block 53). The access governor unit AGU forwards the sampled features, accompanied with a prescribed threshold, to the self-adaptive unit SAU 42a via communication channel CC7 (block 54). The self-adaptive unit SAU then retrieves the required biometric data from the biometric database BDB 42b, via communication channel CC6.

The self-adaptive unit SAU 42a therefore now has the prescribed threshold, the sensed sampled features, and the biometric data retrieved from the biometric database BDB 42b. It determines whether the retrieved biometric data is sufficient to support the specific access requested (block 56). If it is determined to be sufficient to meet the “high” score required for non-restricted access, it return a ‘Grant Access’ code to the access governor unit AGU 41b via communication channel CC7, (block 57), and the AGU approves the access requested to the Application Server 41a via communication channel CC2 (block 58), whereupon the Application Server displays the requested balance in the terminal 12 via communication channel CC1 (block 59).

Since in the flowchart of FIG. 5, the matching score between the sensed biometric data features of the request for access met or exceeded the “high score” required for non-restricted access, the access request was granted. Although the access request was merely to view the bank balance, it would also have been granted if the request were to withdraw a sum from the account.

FIG. 6 is a flow chart illustrating another embodiment where the requested access is to withdraw a sum from the bank account.

In this example, the operations of blocks 60 and 61 are the same as in blocks 50 and 51 of FIG. 5, except the requested access is to withdraw a sum from the bank account. When such a request is made, the access Governor Unit 41b actuates a microphone sensor 13b in the terminal 12 via communication channel CC3 to take a voice sample of the requestor (block 62). The voice sample is sent by the microphone to the access Governor Unit AGU 41b (block 63) via communication channel CC4, which unit forwards the voice sample to the Self-Adaptive Unit SAU 42a (block 64). The Self-Adaptive Unit SAU then retrieves the required voice biometric data from the Biometric Database BDB 42b (block 65) and matches it with the stored template (block 66). In this case, it finds that the voice sample produced a match “score” above the specified “low” score and therefor causes the AGU to actuate the camera sensor to snapshoot a facial sample of the requestor (blocks 67 and 68).

The facial sample is sent to the access Governor Unit 41b, which determines whether the facial sample, as well as the voice sample, when taken together, meets the “high” score required for withdrawing a sum from a bank account. In this case it so determined and therefore it notifies the Application Server AS 41a to execute the action and to so notify the requestor (block 69d-69f).

If the examined voice and facial characteristics did not meet the specified “high” score for the requested operation of withdrawing a sum, this request would be denied, and the denial would be displayed to the requestor in the terminal.

While the latter examples illustrate the operations when the access request is to make a withdrawal of any sum, it will be appreciated that the data processing system could be programmed to permit a plurality of withdrawal access requests to be made, each specifying a maximum withdrawal amount and setting forth higher scores, i.e., more severe biometric characteristics, to verify the identity of the requestor.

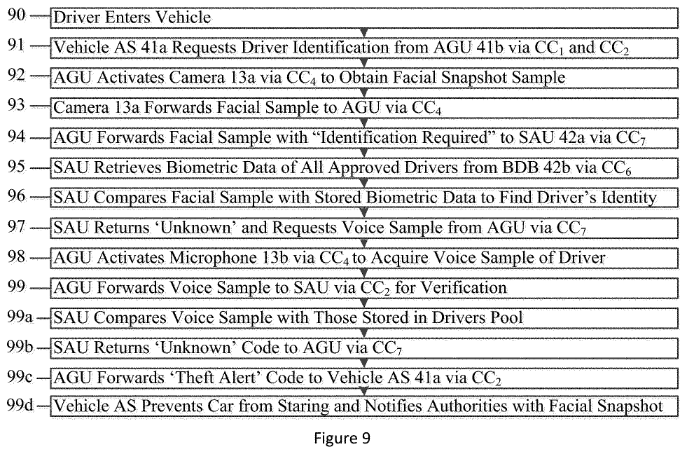

### The Embodiments of FIG. 7-FIG. 10

Many family members may have access to drive a family car. One or more drivers may be required to behave differently, such that it would be desirable to control the access according to the respective driver. For example, one driver may have an unlimited access; and another, for example a teenage driver, may have access only during the day (not at night) or during the weekdays, or only when abiding by specified restrictions as to the geographical area, the speed, type of road, time restrictions, etc.

The invention enables an access-control system to be appropriately programmed in order to allow access according to the above limitations. For example, as the driver enters the driver's seat, the driver is subjected to a biometric examination to determine whether the driver is entitled to any access to the vehicle. In addition, if granted access, whether restricted or unrestricted, the driver's behavior can also be monitored such that if it deviates from specified conditions, a previously granted access can be terminated.

Also, one of the features in an entertainment system (in a motor vehicle and also in a home) is the ability to connect to e-mail, telephone, social networks, and the like. When a person sits in a vehicle driver's seat, or in front of an entertainment system, the person normally obtains access to the entertainment system. However, in many cases, access to specific services may require examination of different biometric characteristics of the person requesting the access, or of thresholds to be met with respect to any biometric characteristic examined. For example, a local camera may first be activated to capture a snapshot for face recognition of the person requesting access, and then a microphone may be activated for voice recognition to verify the identity of the individual requesting access, particularly if the access is unrestricted.

FIG. 7-FIG. 10 are flow diagrams illustrating examples of programming the system of FIG. 1-FIG. 4 for controlling access to a motor vehicle in accordance with the above.

FIG. 7 illustrates the operations performed when the requested access requires an examination of both the facial features (operations 70-76) and the voice features (operations 77-79a), and a comparison of the combination of both features with respect to the scored biometric characteristics retrieved from the biometric data processor, in order to grant the requested access to operate the vehicle (operations 76,79a). Failure to meet these biometric requirements will result in denial of the access in accordance with blocks 34-34c of FIG. 3.

FIG. 7 illustrates the further feature that the access, when granted, may be conditioned on a prescribed behavior, e.g., a particular route, time of day, speed, etc. (block 79d).

The flowchart of FIG. 8 illustrates how the access, when granted, may also be terminated if the behavior of the driver requesting and obtaining access deviates from a prescribed restriction, in accordance with blocks 37-38b of FIG. 3.

FIG. 9 is a flow diagram illustrating the manner in which one requesting access to operate a vehicle is examined to verify that individual's identity (block 90-96). If the identity is not verified, the Self-Adaptive Unit has the access Governor Unit obtain a voice sample from the person making the request, which samples are compared to those previously stored (blocks 97-99a). In this case, no match was found (block 99b), and therefore access was denied. In addition, notification is given to the authorities of the possibility that a theft was attempted, such notification also providing the authorities with a picture of the individual attempting the theft (blocks 99c and 99d).

The flow diagram illustrated in FIG. 10 illustrates the operations performed when an individual requests access to operate various entertainment services available on the motor vehicle. Thus, blocks 100-109a in FIG. 10 correspond to the operations indicated by blocks 90-99a in FIG. 9. Block 109b-109d in FIG. 10, after verifying the identity of the individual requesting access, grant the requested access to perform such entertainment services.

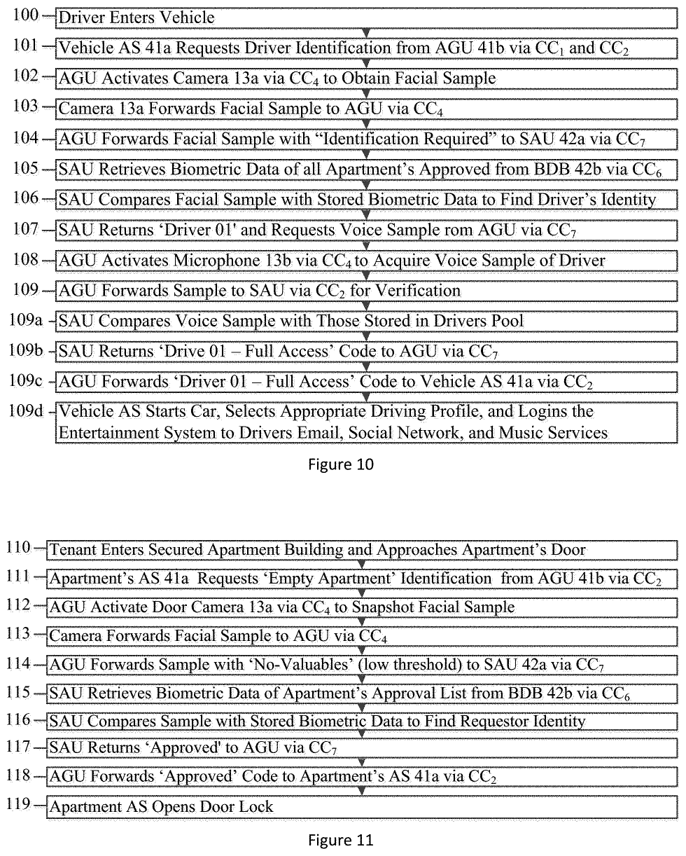

### The Embodiments of FIG. 11 and FIG. 12

FIG. 11 and FIG. 12 are flow diagrams illustrating examples of the operation of the above described system with respect to access to an apartment, namely to provide a non-restricted or less-restricted access where the apartment contains no particular valuables, and a more restricted access where the apartment does contain valuables.

Thus, FIG. 11 illustrates the various operations performed with respect to an apartment containing no particular valuables. The biometric examination is made by a camera 13a, and the access Governor Unit 41b compares the sensed facial data with those stored in the biometric database and determines whether the matching is sufficient to meet at least the low score required for the less-restrictive access to an apartment without valuables (blocks 110-116). If so, it permits access into the apartment (blocks 117-119); but if not, it bars that access.

FIG. 12 is a flow diagram illustrating corresponding operations as in FIG. 11, except there the apartment does contain valuables, and therefore the access requested is restricted only to the individuals also having skeletal features closely matching those stored in the Biometric Database (blocks 126-129a), to better assure the true identity of the individual requesting the access.

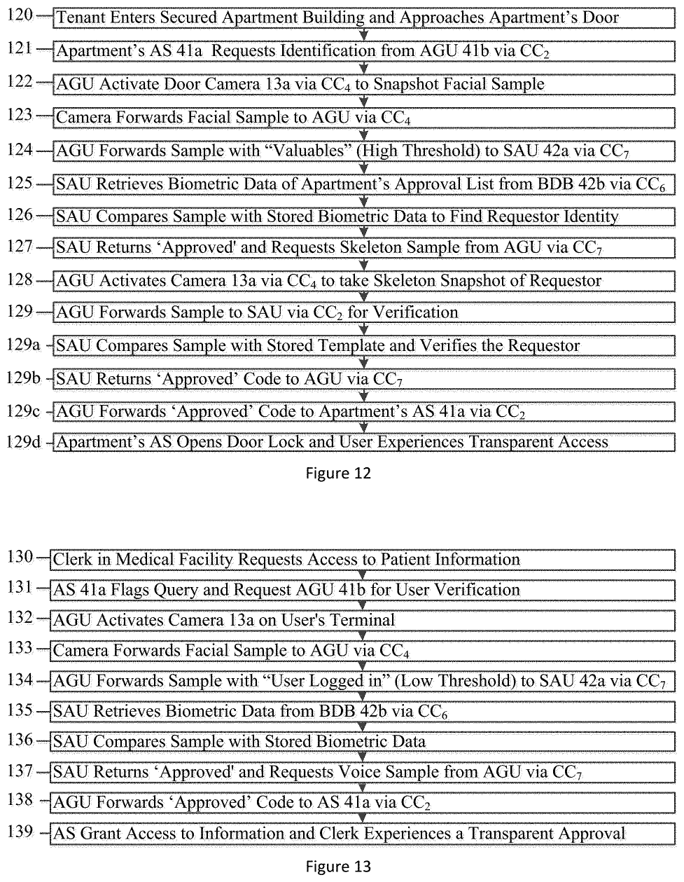

### The Embodiments of FIG. 13-FIG. 15

One of the major problems in governmental agencies, financial institutions, and medical service providers is to prevent an employee from having access to an excessive amount of personal data, beyond the “need to know” for the particular case. Data processing system constructed in accordance with the present invention can be programmed to attain this object.

FIG. 13 is a flow diagram of a data processing system programmed to permit access to medical data of an individual to be so restricted, e.g., to only those having a legitimate “need to know”. Thus, as seen from the flowchart of FIG. 3, if the user logged in to the system, has only a restricted access to certain prescribed data, then the required restricted access is granted. However, if the access requested is to a large amount the data, i.e. beyond that prescribed for a normal operation, then the workstation camera (13a in FIG. 4) will be activated by the AGU (block 132) without notification to capture facial sample in order to verify that the person requesting the information is indeed the logged in user (blocks 134-139).

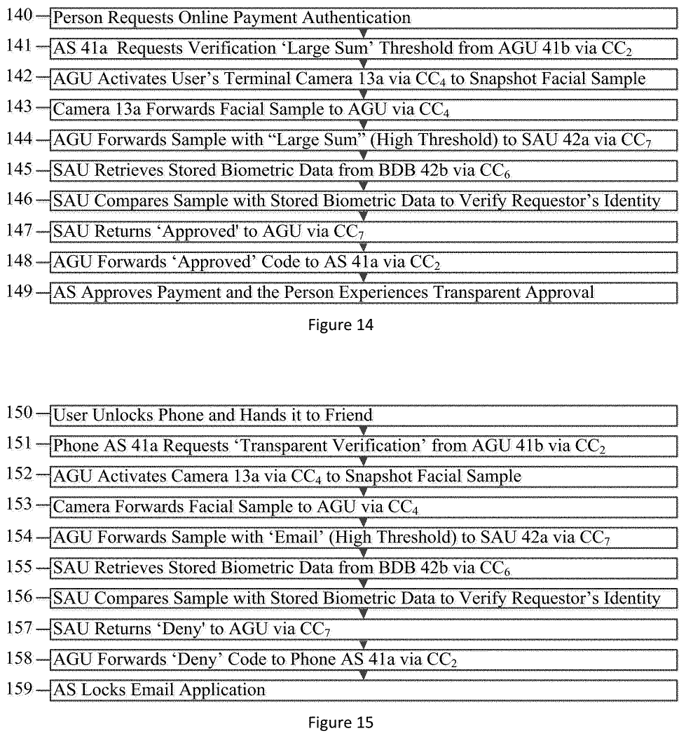

FIG. 14 is a flow diagram illustrating a similar situation as FIG. 13, except where the access request is to allow for online payments. Online and mobile payments are very common practices, but are vulnerable to fraud. FIG. 14 illustrates how a system constructed in accordance with the present invention can be programmed to minimize the possibility of this type of fraud. Thus, as shown in FIG. 14, if the first biometric examination (in this case a facial examination) produces a match score which equal or exceeds the “high” score stored in the Biometric Database BDB, the requested access is granted without subjecting the individual to a further biometric examination irrespective of the amount involved. However, if the “score” is below the requested “high” score, then one or more additional biometric examinations are conducted to verify, with more certainty, the true identity of the individual making the request.

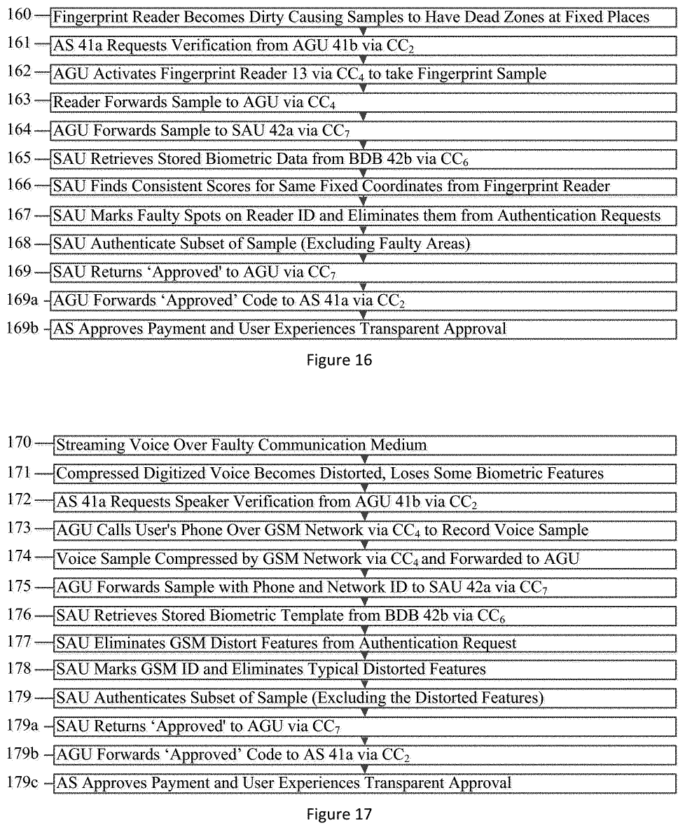

The flow diagram of FIG. 15 illustrates a system which is similarly programmed for enabling access to various uses of a mobile telephone. Mobile telephones provide digital assistance for daily tasks. When a user hands the user's mobile telephone to another to make a call, all the e-mails, mobile banking settings, and social network sites are open to that other person, and therefore are vulnerable to misuse or even fraud. FIG. 15 illustrates how a system constructed in accordance with the present invention can be programmed to minimize this possibility of misuse or fraud.

FIG. 15 illustrates the situation wherein the unlocking examination allows only restricted access, but for a non-restricted access, another biometric examination is conducted (e.g., a facial snapshot, as indicated by block 154), to verify the identity of the person requesting the access. Block 157 shows an examination that results in a score below the “low score” stored in the Biometric Database. Accordingly, the request is immediately denied without making the second biometric examination (blocks 158-159).

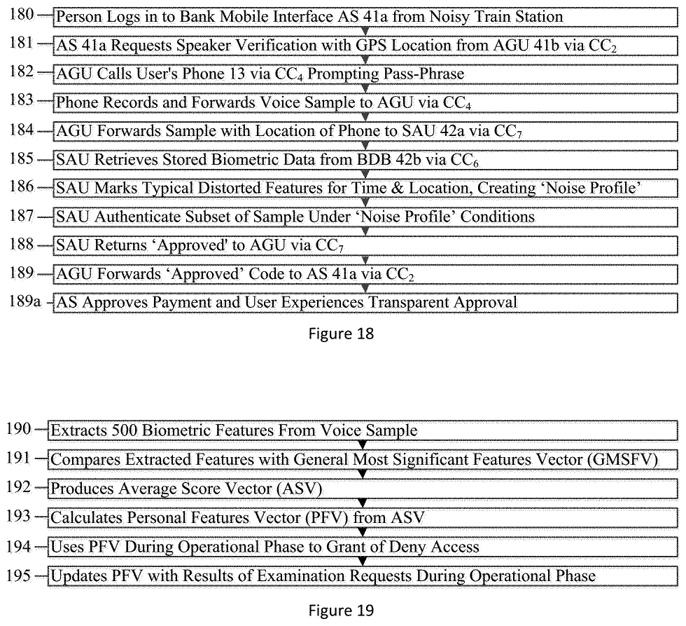

### The Embodiments of FIG. 16-FIG. 18

One of the problems of an access-control system based on biometric examination is degradation in the quality of the sensor during use. Thus, fingerprint readers may become dirty, the angle of a camera to the face may change, and the quality of a microphone or its telephone line may decrease over a period of time. In addition, an available communication channel, such as GSM of Wi-Fi, can become noisy at times. The present invention enables the data processing system to be programmed so as to reduce the effects of degradation in the sensor environmental, or in a communication channel, by ether ignoring the effects caused by such degradation, or by selecting another available channel.

FIG. 16 illustrates the manner of programming and operating the data processing system in order to reduce the effects of degradation of a fingerprint sensor.

Thus, as indicated by block 160 in FIG. 16, fingerprint readers become dirty causing the scanned fingerprint to have dead zones at fixed places. The illustrated operations of FIG. 16 show how the system learns to ignore such degraded or dead zones in the fingerprint reader.

FIG. 17 is a flow diagram illustrating how the system may be programmed in order to reduce the effects of degradation in the sensor communication channels. This figure refers particularly to a system utilizing voice characteristics for verifying the identity of the individual requesting the access, and shows how the system can be programmed to learn to ignore such degradations in these communication channels in processing requests for access during the operational phase.

FIG. 18 is a flow diagram illustrating how the system may be programmed in order to reduce the effects of a noisy communication channels with respect to a request for access to a bank account e.g., by a telephone at a noisy train station. The environmental noise existing at that location is learned by the system and used to change (i.e., update or reset) the stored respective template in order to reduce or ignore such effects.

### The Embodiment of FIG. 19

FIG. 19 illustrates an embodiment wherein the programmed data processor system automatically creating and also updates or resets the stored enrollee biometric/threshold data template in a self-adaptive manner according to the biometric/threshold data found most relevant in processing prior to the access requests.

Thus, as shown the in the flow diagram of FIG. 19, the program data processor system is programmed: to extract a predetermined number of biometric features from a biometric sample (in this case, 500 features from a voice sample, as shown by block 190); to compare the extracted features with a vector GMSFV, representing the features having the highest standard deviation of the general enrollee population (block 191), to produce an average score vector ASV, representing for each feature, the difference between each GMSFV feature and the corresponding extracted feature (block 192); and to calculates from the vector ASV, a vector PFV, representing the features which have the most difference from the corresponding features of the vector GMSFV (block 193). Block 193 and 194 illustrates how vector PFV is used during the operational phase in comparing the features of the received biometric sample with those stored in the template, and in determining from such comparison whether or not to grant or deny the requested access.

While the invention has been described with respect to a large number of preferred embodiments, it will be appreciated that these are set merely for purposes of example, and that many other embodiments, variations and applications of the invention may be made.

What is claimed is:

1. A method of processing requests for access to one or more particular activities by utilizing one or more biometric/threshold data examinations to verify an identity of a respective requestor comprising:
enrolling and storing a template of biometric/threshold data identifying an enrollee in a data processor system;
receiving of one or more biometric samples of the respective requestor by the data processor system upon request of access to the one or more particular activities;
permitting a more-restricted or a less-restricted access to the one or more particular activities to be granted by specifying in the stored template, the enrollee biometrics/threshold data required for the more-restricted access and the enrollee biometrics/threshold data required for the less-restricted access;
sensing and comparing corresponding biometric/threshold data of the respective requestor from the received one or more biometric samples with the biometric/threshold data in the stored template; and
determining whether to grant or deny the requested access.

2. The method according to claim 1, wherein the method includes:
(a) granting an unrestricted access when one or more comparisons result in a matching score which is equal to or exceeds at least a first defined threshold stored in the data processor system;
(b) denying any access when one or more comparisons result in a matching score which is below at least a second defined threshold stored in the data processor system; and
(c) requiring another biometric sample of the requestor if the matching score is below one or more defined thresholds to be received, sensed and compared, together with the one or more biometric samples in determining whether or not to grant a restricted access.

3. The method according to claim 2, wherein the method includes processing a request for one of a plurality of different levels of restricted access, each level having a different defined threshold to be met for respective level of restricted access to be granted.

4. The method according to claim 1, wherein the method includes permitting a plurality of different thresholds to be specified for one or more biometric characteristics in determining whether to grant or deny the requested access.

5. The method according to claim 1, wherein the method includes permitting a plurality of different biometric characteristics to be specified in determining whether to grant or deny requested limited or unlimited access.

6. The method according to claim 1, wherein:
the biometric/threshold data is stored in a database of the data processor system;
the requests for access are received in an application server in the data processor system communicating with the database;
the requests for access are processed in an access governor unit in the data processor system;
and the determinations of whether or not the requests for access are granted or denied are determined by a self-adaptive unit in the data processor system communicating with the access governor unit and the application server.

7. The method according to claim 1, wherein the method includes subjecting the requestor to at least one additional biometric/threshold data examination if the requested access is denied and also using the results of the at least one additional biometric/threshold data examination in determining whether to grant or deny the requested access.

8. The method according to claim 1, wherein when granting the requested access, the method includes monitoring the subsequent behavior of the requestor and terminating the granted access if the subsequent behavior fails to meet a stored specified condition.

9. The method according to claim 1, wherein the method includes automatically updating the stored enrollee biometric/threshold data template in a self-adaptive manner according to the biometric/threshold data found most relevant in processing prior access requests.

10. The method according to claim 1, wherein the method includes:
extracting a predetermined number of biometric features from the one or more biometric samples;
assigning a score to the extracted predetermined number of biometric features; wherein the score assigned to one or more biometric features is variable depending on the distance from one or more characteristics of the one or more biometric features in a general population;
comparing the extracted predetermined number of biometric features with a General Most Significant Features Vector (GMSFV), wherein the General Most Significant Features Vector (GMSFV) represents the biometric features having the highest standard deviation of a general enrollee population;
producing an Average Score Vector (ASV), wherein the Average Score Vector (ASV) represents for each biometric feature, the difference between each General Most Significant Features Vector (GMSFV) biometric feature and the corresponding extracted biometric feature;
determining from the Average Score Vector (ASV), a Personal Features Vector (PSV), wherein the Personal Features Vector (PSV) represents the biometric features which have the most difference from the corresponding biometric features of the General Most Significant Features Vector (GMSFV);
utilizing the Personal Features Vector (PSV) in comparing the biometric features of the received biometric sample with those stored in the template; and
determining from such comparison whether or not to grant or deny the requested access.

11. The method according to claim 10, wherein the method includes updating the Personal Features Vector (PSV) in accordance with previous examinations of enrollees.

12. The method according to claim 1, wherein the method includes:
permitting access to bank accounts including: storing a predetermined biometric/threshold data template for a restricted access for only viewing a bank balance; and storing a more severe biometric/threshold data template for a non-restricted access for also withdrawing sums from the bank account; or
permitting access to a motor vehicle including: storing a predetermined biometric/threshold data template for a restricted access restricted to specified time, place, speed or other driving conditions; and storing a more severe biometric/threshold data template for a non-restricted access; or
permitting access to an apartment including: storing a predetermined biometric/threshold data template for a restricted entry into an apartment when it does not contain valuables and/or one or more individuals; and storing a more severe biometric/threshold data template for a non-restricted entry into an apartment when containing valuables and/or one or more individuals; or
permitting access to personal information including: storing a predetermined biometric/threshold data template for a restricted access to a prescribed limited amount of information; and storing a more severe biometric/threshold data template for a non-restricted access to an unlimited amount of information; or
permitting access to make online payments including: storing a predetermined biometric/threshold data template for a restricted access to specified small payments; and storing a more severe biometric/threshold data template for a non-restricted access to unlimited payments; or
permitting access to a phone including: storing a predetermined biometric/threshold data template for a restricted use; or storing a more severe biometric/threshold data template for a non-restricted use.

13. A method of processing requests for access to one or more particular activities by utilizing one or more biometric/threshold data examinations to verify an identity of a respective requestor comprising:
enrolling and storing a template of biometric/threshold data identifying an enrollee in a data processor system;
receiving of one or more biometric samples of the respective requestor by the data processor system upon request of access to the one or more particular activities;
extracting a predetermined number of biometric features from the one or more biometric samples;
assigning a score to the extracted predetermined number of biometric features;
wherein the score assigned to one or more biometric features is variable depending on the distance from one or more characteristics of the one or more biometric features in a general population;
comparing the extracted predetermined number of biometric features with a General Most Significant Features Vector (GMSFV), wherein the General Most Significant Features Vector (GMSFV) represents the biometric features having the highest standard deviation of a general enrollee population;
producing an Average Score Vector (ASV), wherein the Average Score Vector (ASV) represents for each biometric feature, the difference between each General Most Significant Features Vector (GMSFV) biometric feature and the corresponding extracted biometric feature;
calculating from the Average Score Vector (ASV), a Personal Features Vector (PSV), wherein the Personal Features Vector (PSV) represents the biometric features which have the most difference from the corresponding biometric features of the General Most Significant Features Vector (GMSFV);
utilizing the Personal Features Vector (PSV) in comparing the biometric features of the received biometric sample with those stored in the template; and
determining from such comparison whether or not to grant or deny the requested access.

14. The method according to claim 13, wherein the method includes updating said Personal Features Vector (PFV) in accordance with previous examinations of enrollees.

15. The method according to claim 13, wherein the method includes:
permitting a more-restricted or a less-restricted access to the particular activity to be granted by specifying in the stored template, the enrollee biometrics/threshold data required for the more-restricted access and the enrollee biometrics/threshold data required for the less-restricted access;
sensing and comparing corresponding biometric/threshold data of the requestor from the received one or more biometric samples with the biometric/threshold data in the stored template; and determining whether to grant or deny the requested access.

16. An apparatus comprising:
a data processor system including:
a) one or more input devices;
b) a database for storing biometric/threshold data;
c) an application server communicating with said database for receiving access requests during an operational phase;
d) an access governor unit for receiving said access requests from an application server during the operational phase; and
e) a self-adaptive data unit communicating with said access governor unit and said application server for determining whether said access requests are granted or denied; and
wherein the data processor system processes one or more requests for access to one or more particular activities by utilizing one or more biometric/threshold data examinations to verify an identity of an individual making the one or more requests;
wherein the data processor system is programmed to operate in an enrollment phase, in which a template of biometric/threshold data identifying an enrollee is stored in the data processor system; and in the operational phase, in which each requestor, when requesting, via said one or more input devices, access to a particular activity, causes the data processor system to receive a biometric sample of the respective requestor, to compare the features of the received biometric sample with those stored in the template, and to determine from such comparison whether or not to grant or deny the requested access; and
wherein the data processor system is programmed to permit a more-restricted or a less-restricted access to the particular activity to be granted by specifying in the stored template the enrollee biometrics/threshold data required for the more-restricted access and the enrollee biometrics/threshold data required for the less-restricted access; and during the operational phase, to sense and compare the corresponding biometric/threshold data of the requestor with that in the stored template in determining whether to grant or deny the requested access; and
wherein said programmed data processor system automatically updates the stored enrollee biometric/threshold data template in a self-adaptive manner according to the biometric/threshold data found most relevant in processing prior access requests.

17. The apparatus according to claim 16, wherein said data processor system during the operational phase:
(a) grants an unrestricted access when one or more comparisons result in a matching score which is equal to or exceeds at least a first defined threshold stored the data processor system;
(b) denies any access when one or more comparisons result in a matching score which is below at least a second defined threshold stored in the data processor system; and
(c) requires another biometric sample of the requestor if the matching score is below one or more defined thresholds to be received, and to be used together with the one or more biometric samples in determining whether or not to grant a restricted access.

18. The apparatus according to claim 16, wherein the data processor system includes one or more of the following:
wherein said data processor system processes a request for one of a plurality of different levels of restricted access, each level having a different threshold to be met for respective level of restricted access to be granted;
wherein said data processor system permits a plurality of different thresholds to be specified for a biometric characteristic in determining whether to grant or deny the requested access; and
wherein said data processor system permits a plurality of different biometric characteristics to be specified in determining whether to grant or deny the requested access.

19. An apparatus for processing a request for access to particular activities by utilizing biometric/threshold data examinations to verify an identity of an individual making the request comprising:
a data processor system, wherein the data processor system is programmed to:
extract a predetermined number of biometric features from a biometric sample;
compare the extracted biometric features with a General Most Significant Features Vector (GMSFV), representing the biometric features having the highest standard deviation of a general enrollee population, to produce an Average Score Vector (ASV), representing for each biometric feature, the difference between each General Most Significant Features Vector (GMSFV) biometric feature and the corresponding extracted biometric feature;
and determine from the Average Score Vector (ASV), a Personal Features Vector (PSV), representing the biometric features which have the most difference from the corresponding biometric features of the General Most Significant Features Vector (GMSFV), to be used during the operational phase in comparing the biometric features of the received biometric sample with those stored in the template, and in determining from such comparison whether or not to grant or deny the requested access.

20. The apparatus according to claim 19, wherein said Personal Features Vector is updated during the operational phase in accordance with previous examinations of enrollees.
